(19) United States
(12) Patent Application Publication
(10) Pub. No.: US 2014/0169921 A1
(43) Pub. Date: Jun. 19, 2014

(54) CARGO CARRIER

(71) Applicant: Mark Carey, Upper Sandusky, OH (US)

(72) Inventor: Mark Carey, Upper Sandusky, OH (US)

(21) Appl. No.: 14/098,939

(22) Filed: Dec. 6, 2013

Related U.S. Application Data
(60) Provisional application No. 61/739,491, filed on Dec. 19, 2012.

(51) Int. Cl. B62B 3/02

(52) U.S. Cl. CPC B62B 3/022
USPC 414/495; 414/812

(57) ABSTRACT

A cargo carrier is provided that includes a load carrying platform, a retractable front axle and a retractable rear axle. The cargo carrier further includes a pivotal handle operatively connected to front and rear axles that when activated retracts or un-retracts the front and rear axles. A removable/pivotal handle attached to a front of the cargo carrier for transporting the cargo carrier.

### CROSS-REFERENCE TO RELATED APPLICATIONS

This application claims the benefit of U.S. Provisional Patent application Ser. No. 61/739,491 entitled “CARGO CARRIER” filed on Dec. 19, 2012. The entirety of the above-noted application is herein incorporated by reference.

### ORIGIN

The innovation disclosed herein relates to a maneuverable cargo carrier and more specifically, to a cargo carrier having retractable wheels and a means to attach the cargo carrier to a hitch of a vehicle.

### BACKGROUND

Utility carts are used to haul objects from one location to another. Many of these objects are heavy, large, bulky or too plentiful to move and, thus, require the assistance of the utility cart. Although the amount of utility carts known for hauling objects is numerous, conventional utility carts lack certain attributes. For example, it is difficult to load and unload objects on to and off of conventional utility carts due to the raised loading platform. In addition, conventional utility carts are rather large and require a sizable storage area. Still further, the large size of the conventional utility cart prohibits easily transporting the utility cart from location to location. Specifically, conventional utility carts are not readily adaptable to easily load into a vehicle or attach to a vehicle for transport.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In accordance with one aspect, the innovative cargo carrier described herein includes vertically translating wheels/axles for the purpose of raising and lowering a load carrying platform. This action allows the potential user the ability to (with either mechanical advantage, stored power assistance or both) negotiate heavy loads with very small force inputs as compared to said load. One advantage of this invention is the overall simplicity of its mechanism and function. This allows for both enhanced mechanical advantage (with “gravity” assistance being taken advantage of with “pre-load” gas struts to minimize the maximum applied force balance between an “empty/no load” cart and a fully loaded cart) and robust, simply lever design for both cost advantage and overall safety of said mechanism's system performance. In short; simply, reliable, strong, robust, and safe.

In accordance with another aspect, the innovative cargo carrier includes a low angle “ramp” type shape to carrier's load bearing platform. With the gate/ramp in its lowered, ramp down position, the structure of the carrier allows additional stiffness and load carrying robustness to provide weight support to any required use of the load platform as a general walk-way by operator(s); dragging, walking on, or lever-arming said surface to perform the general loading of the carrier. In other words, when the carrier is in a crouched position, if two heavy operators carry the intended load onto the carrier by means of walking up the load carrying platform, their additional loaded weight is well supported and re-distributed to the surface the carrier is crouching upon. As long as their load is removed (assuming they are not a portion of the intended maximum load), the carrier only needs to be designed and built to carry the maximum design load when raised to an un-crouched(upright) position for horizontal

In still yet another aspect of the innovation, the innovative cargo carrier includes a loading bed, a removable handle attached to the loading bed, a pair of retractable front wheels attached to the loading bed, a pair of retractable rear wheels attached to the loading bed, and a retractable assembly connected to the retractable front wheels and the retractable rear wheels. The actuation of the retractable assembly retracts the retractable front wheels and the retractable rear wheels rearward and upward toward the loading bed.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a perspective view of a cargo carrier in accordance with an aspect of the innovation.

FIG. 2 is a perspective view of a cargo carrier without the handle attached in accordance with an aspect of the innovation.

FIG. 3 is a front view of the cargo carrier of FIG. 2 in accordance with an aspect of the innovation.

FIG. 4 is a side view of the cargo carrier in the raised position in accordance with an aspect of the innovation.

FIG. 5 is a side view of the cargo carrier in the collapsed position in accordance with an aspect of the innovation.

FIG. 6 is a view of a hitch attachment member for attachment to a vehicle hitch in accordance with an aspect of the innovation.

FIG. 7 is a view illustrating the attachment of the cargo carrier to the vehicle hitch in accordance with an aspect of the innovation.

FIG. 8 is a view of a hitch attachment lever in accordance with an aspect of the innovation.

FIG. 9 is a side view of the cargo carrier of attached to a vehicle hitch in accordance with an aspect of the innovation.

FIGS. 10 and 11 are side views of the cargo carrier with a load in a raised and collapsed position respectively in accordance with an aspect of the innovation.

FIGS. 12 and 13 are perspective and rear views respectively of another embodiment of a cargo carrier in accordance with an aspect of the innovation.

FIG. 14 is a flow chart illustrating a method of loading/unloading objects from the cargo carrier in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

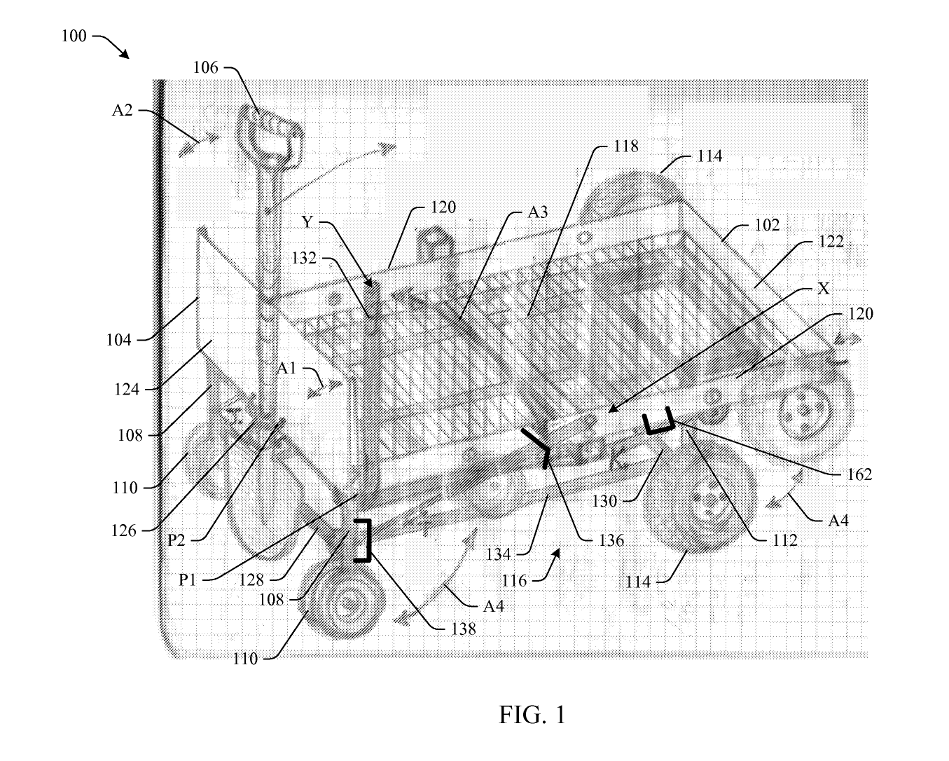

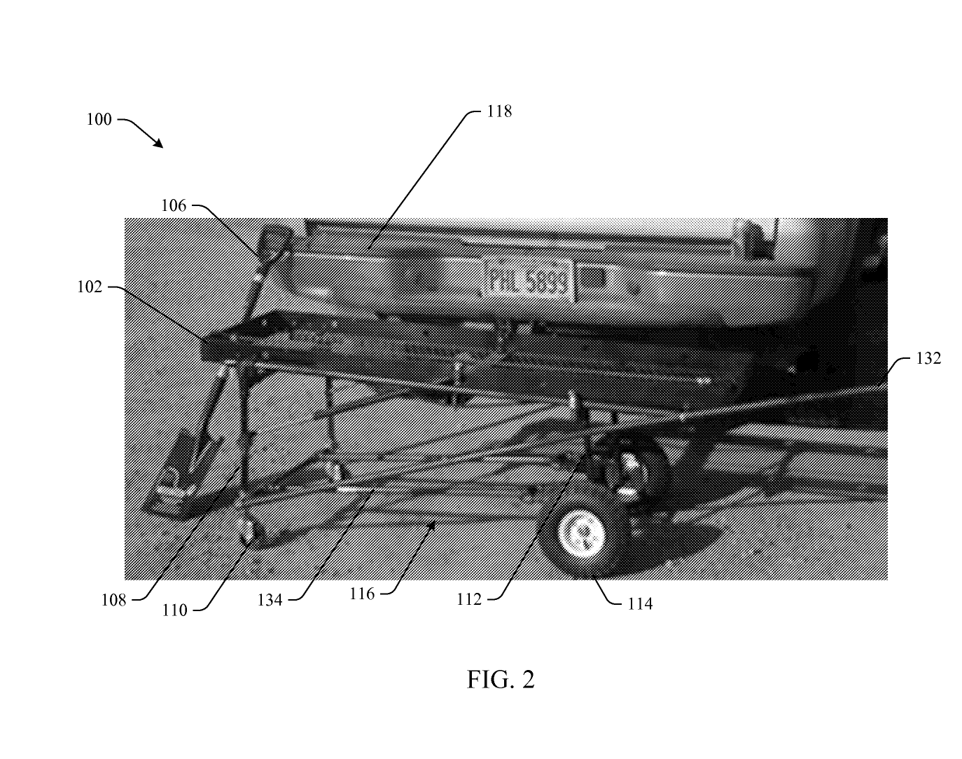

With reference now to the drawings, FIGS. 1 and 2 are perspective views of a maneuverable cargo carrier (utility cart) 100 in accordance with an aspect of the innovation. As will be described further below, the innovative cargo carrier 100 is adapted to collapse to a loading/unloading position to facilitate loading and unloading objects from the cargo carrier 100. The cargo carrier 100 is also adapted to easily mount on a vehicle hitch for easy transport from one location to another. In addition, the cargo carrier 100 is further adapted to include a removable handle that also functions as a hand tool.

The cargo carrier 100 includes a loading bed 102, an optional ramp/gate 104 hingedly attached to a front of the loading bed 102, a handle 106 attached to the ramp/gate 104, a pair of front legs 108 having wheels 110 attached thereto, a pair of rear legs 112 having wheels 114 attached thereto, and a retracting assembly 116 that retracts the front and rear legs 108, 112 and, hence, the front and rear wheels 110, 114 rearward and upward toward the loading bed 102 to facilitate the loading/unloading of objects and the transporting of the carrier on a rear of a vehicle.

The loading bed 102 is a generally flat-platform type base 118 that may include a mesh type platform, a solid platform, combination of the two, etc. The loading bed 102 may include oppositely disposed sidewalls 120 and a rear wall 122. Thus, the combination of the ramp/gate 104, the two sidewalls 120 and the rear wall 122 form an open-top enclosure around a perimeter of the base 118.

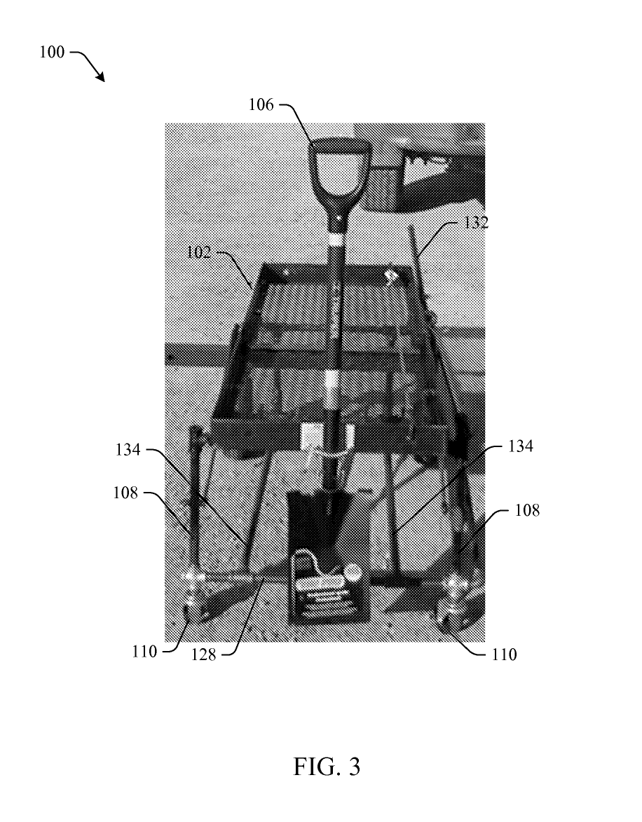

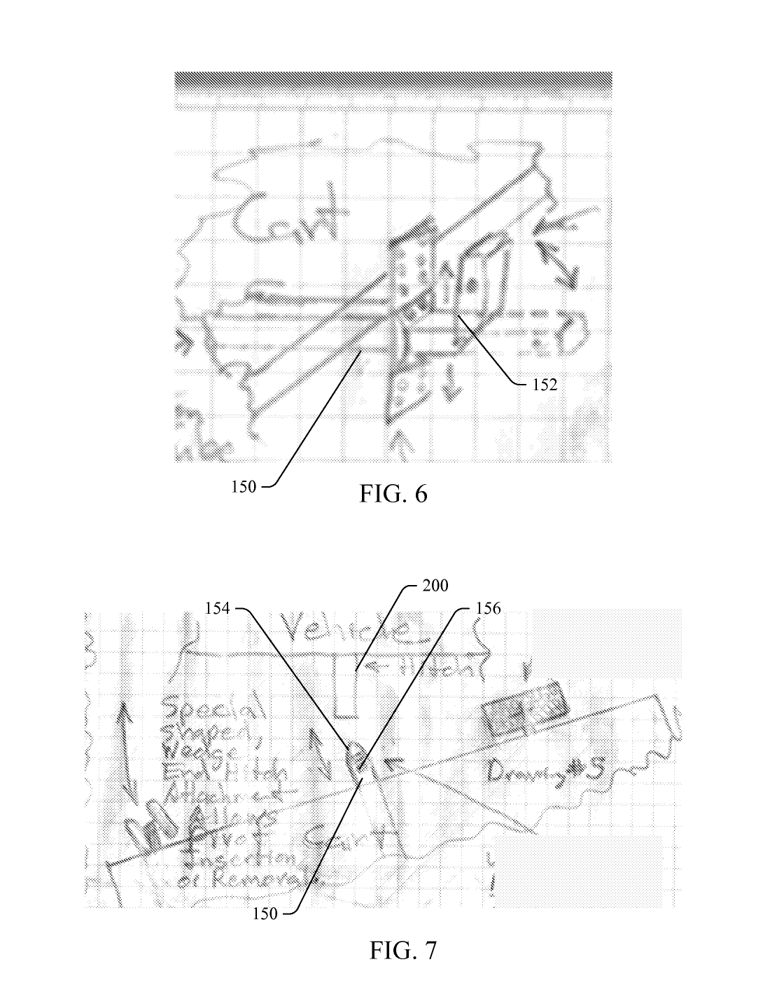

The ramp/gate 104 is hingedly attached to the front of the loading bed 102 and serves as a front wall to the loading bed 102. In another example embodiment, a ramp/gate may be included on a rear of the loading bed 102 in addition to or instead of the front ramp/gate 104. The ramp/gate 104 can pivot about a point P1 in a downward direction indicated by the arrow A1 and thus, can serve as an angled-adjustable ramp serving as an extension of the base 118 to facilitate the loading and unloading of objects to and from the loading bed 102 when the cargo carrier 100 is in a collapsed position (see FIGS. 5 and 11). In another example embodiment shown in FIGS. 2 and 3, the carrier 100 may not include the ramp/gate described above, but may still utilize a hand tool as the handle 106.

The handle 106 attaches to a front surface 124 of the ramp/gate 104 via removable fasteners (e.g., screws, nuts and bolts, etc.) or a spring clip. The spring clip 126 is a quick disconnect vertical positioning/safety spring that facilitates a quick method to connect and disconnect the handle 126 to and from the ramp/gate 104. The spring clip 126 also allows the handle 106 to pivot about a point P2 in the direction indicated by arrow A2 for transporting the carrier 100 and for attachment to a hitch to allow the carrier 100 to be towed. For example, the carrier 100 may include a hitch handle adaptor that provides the means to quickly and easily turn the grip of the handle 106 into a pivoting tongue attachment point for attachment to a hitch for towing purposes. Thus, in one example embodiment, the handle 106 may be removable and may serve multiple functions. First, the handle 106 serves as a handle to pull or push the cargo carrier 100. Second, the handle 106 may serve as a hand tool. In other words, the handle 106 can be any type of hand tool, such as but not limited to, a shovel as illustrated in the figures, a rake, a hoe, etc. In order to use the handle 106 as a hand tool, the handle 106 is simply removed from the ramp/gate 104 by removing the removable fasteners.

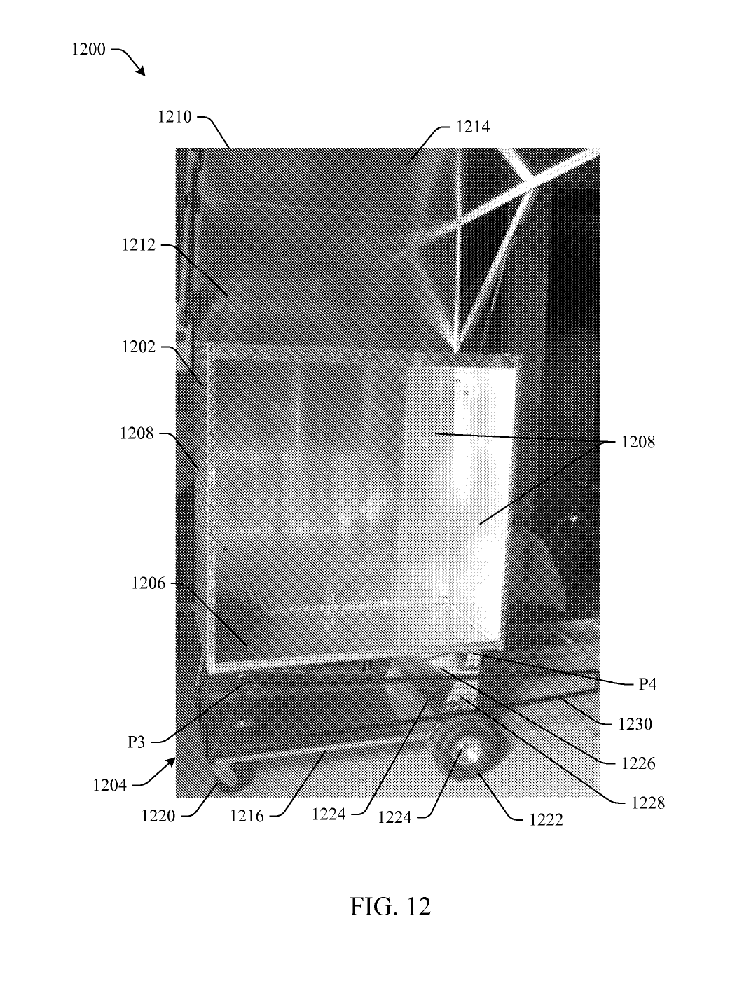

In another example embodiment shown in FIGS. 10 and 11, the removable handle 106 may be replaced with a sturdier handle 106A for heavy load applications. In still yet another example embodiment, the carrier 100 may be electrically and/or fuel powered to provide heavy load, rough terrain operational assistance to the operator.

The removable handle 106 provides both the ability to change the type of handle attached to the cart during operation, but also the ability to remove it for ground clearance when the carrier 100 is collapsed during loading and unloading of objects or when the carrier 100 is attached to a vehicle during transport. In one example, the removable fasteners/quick disconnect 126 may also serve as a lock-out to prevent the carrier 100 from being collapsed until the handle 106 has been removed.

Still referring to FIG. 1, the pair of front legs 108 are connected by a front connector 128 (e.g., rod, tube, plate, etc.) and the pair of rear legs 112 are connected by a rear axle 130. The front wheels 110 are attached to a distal end to the pair of front legs 108 and the rear wheels are attached to a distal end of the pair of rear legs 112. The front wheels 110 (e.g., rubber, solid, pneumatic, steel, etc.) pivot (e.g., castor wheels) about a point at the distal end of the pair of front legs 108 to facilitate steerability, whereas the rear wheels 114 are fixed type wheels (e.g., rubber, solid, pneumatic, steel, etc.). This configuration allows for the elimination of a front steerable axle and improves the general robustness of the operation of the retracting assembly 116. It is to be appreciated, however, that the use of various front and/or rear steerable wheel axles and/or selectable castor pivot/fixed operation is included in the scope of the innovation.

The front and/or the rear wheels 110, 114 may be fitted with some means of braking to provide for inadvertent movement of the carrier 100 during loading and unloading of objects or to lock the wheels 110, 114 during transport. In one example embodiment, the braking means could be the interference between an inside surface of the front and/or rear wheels 110, 114 when the carrier is in the collapsed position.

Still referring to FIG. 1, the retracting assembly 116 retracts the front and rear legs 108, 112 from a hauling position toward the loading bed 102 to facilitate the loading/unloading of objects (loading/unloading position) and the transporting of the carrier on a rear of a vehicle (transporting position). The retracting assembly 116 includes a retraction lever 132 and one or more connecting rods (or links) 134. The retraction lever 132 can be attached, either integrally or via linkage, to any one of (or more) the front legs 108, one of the rear legs 112, the front connector 128 or the rear axle 130. In addition, in one example embodiment, the retraction lever 132 may itself be retractable (or telescoping) to adjust a length of the lever 132. The connection rod(s) 134 provides a connection between the front connector 128 and rear axle 130 and, hence the front legs 108 and the rear legs 112.

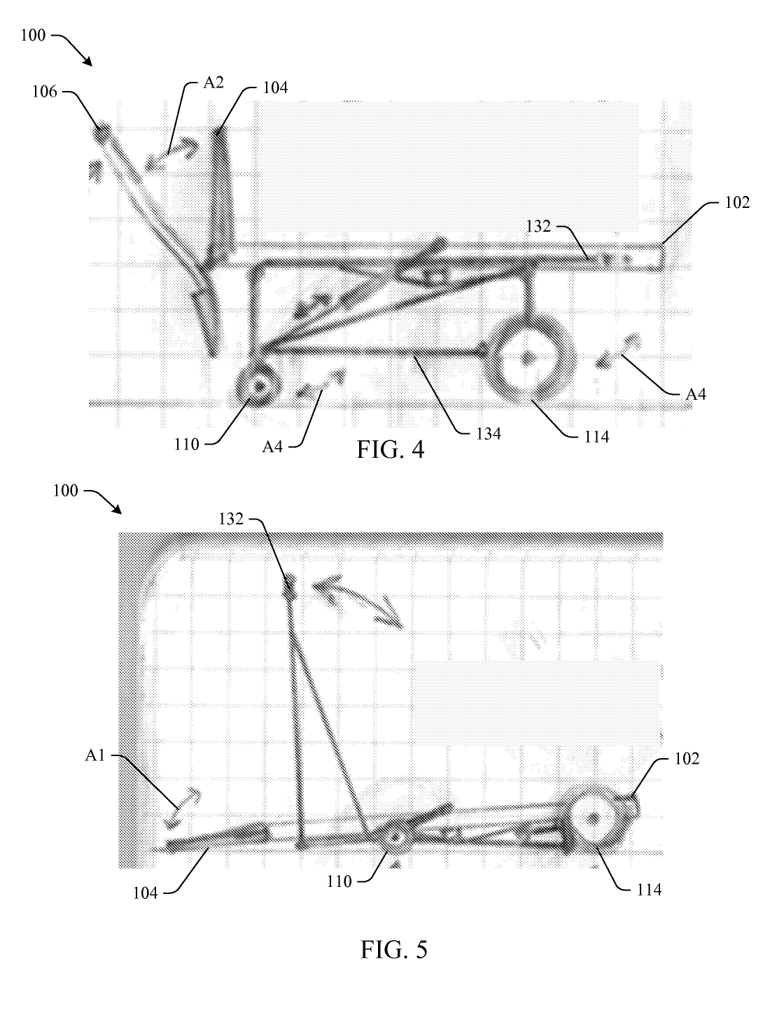

When the retracting lever 132 is in position X, the front and rear legs 108, 112 are in an un-retracted position (hauling position), as shown in FIGS. 4 and 10. In this position, the carrier 100 can be wheeled via the handle 106 to move objects from one location to another location, see FIG. 10. A locking mechanism 136 may be included to lock the lever 132 and hence the front and rear legs 108, 112 in position X to prevent the carrier from collapsing during operation. When the retracting lever 132 is in position Y, the front and rear legs 108, 112 are in a retracted position, as shown in FIG. 11. In this position, the carrier 100 is collapsed (loading/unloading position) and can easily be loaded with objects or the carrier 100 can be attached to a vehicle, as shown in FIGS. 5 and 11, for transporting purposes.

To retract the front and rear legs 108, 112, the retracting lever 132 is moved from position X to position Y, as indicated by the arrow A3. To un-retract the front and rear legs 108, 112, the retracting lever 132 is moved from position Y to position X. The movement of the front and rear legs 108, 112, and hence, the front and rear wheels 110, 114 is indicated by the arrows A4.

The simple lever operation provides both the required action for both collapsing the carrier 100 for efficient loading/unloading of objects to and from the loading bed 102. In addition, this basic operation is the general means of attaching the carrier 100 to the vehicle even under various hitch mounting heights due to variation in terrain, horizontal parking angle, multiple vehicle types, etc.

In one example embodiment, a powered actuator(s) 138 (e.g., gas struts, electric actuators, etc.) may be included to facilitate the movement of the carrier 100 from a collapsed position or vice-versa to an upright position in the event of a heavy load, see FIG. 1. The powered actuator 138 may be connected to the any one or a combination of the front or rear legs 108, 112, the retractable assembly 116, or the front or rear axles 128, 130.

Referring to FIG. 3, a hitch attachment member 150 may be included for attachment of the carrier 100 to a vehicle in accordance with an aspect of the innovation. The hitch attachment member 150 extends out horizontally from one side of the carrier 100 and has a similar cross sectional shape as the hitch on the vehicle. Thus, the hitch attachment member 150 simply slides into the vehicle hitch to mount the carrier 100 to the vehicle.

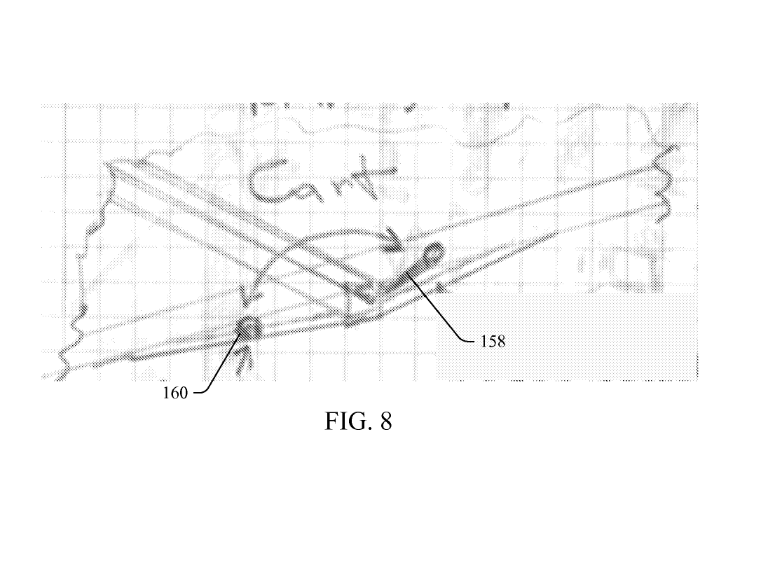

As shown in FIG. 6, the hitch attachment member 150 may include a pivot attachment tube 152 that allows the carrier 100 to fold up when attached to the vehicle to thereby reduce the amount that the carrier sticks out during transport. In addition, the pivot attachment tube 152 allows the hitch attachment member 150 to pivot via weight/gravity and/or spring powered to provide for improved clearance and safer operational use and to eliminate the hitch attachment member from horizontally sticking out when the carrier 100 is in use.

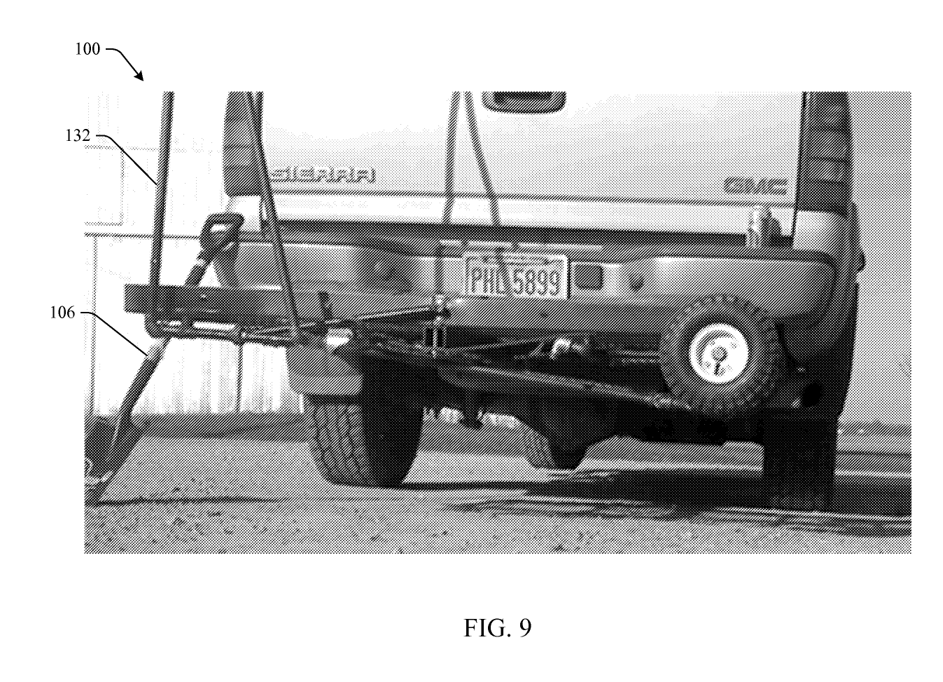

Referring to FIG. 7, in another example embodiment, the hitch attachment member 150 may have a tapered end 154 and bearings (or rollers) 156 to facilitate the insertion of the hitch 150 into the vehicle hitch 200. The tapered end 154 may be tapered on any one of the top, bottom, one or both sides, or a combination thereof. This configuration has the ability to pivot the hitch attachment member 150 into the vehicle hitch 200. Specifically, the wedge shape allows the user to pivot the hitch 150 into the vehicle hitch 200. Once partially inserted, the bearings 156 facilitate the insertion of the hitch 150 into the vehicle hitch 200.

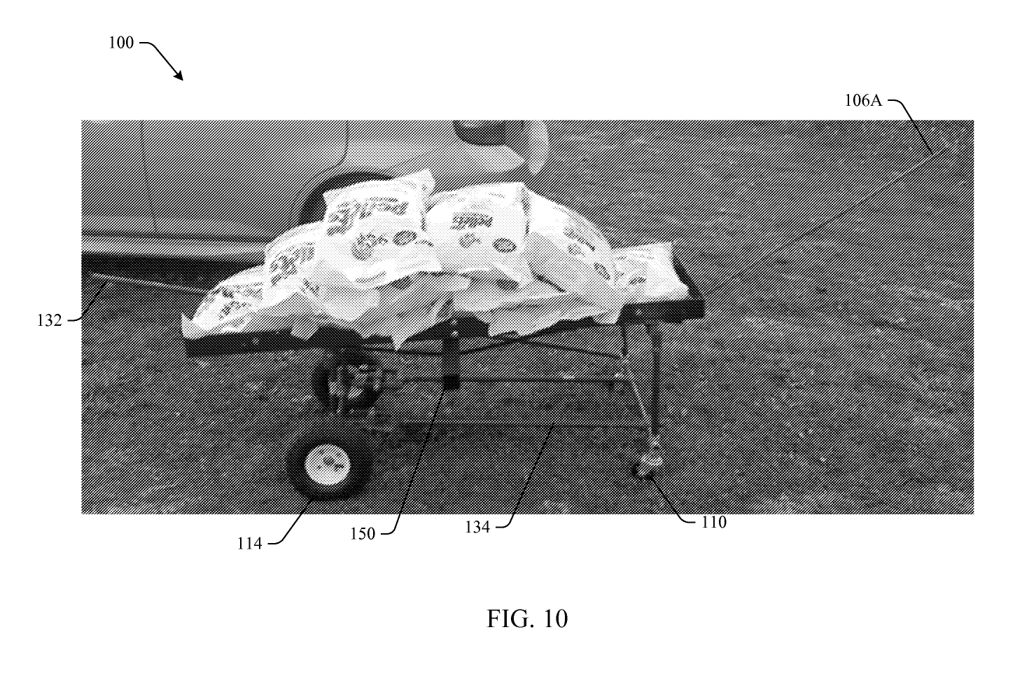

Once the carrier is loaded onto the vehicle and positioned in a transport position, one or more hitch attachment levers 158 (see FIG. 8) can be included to actuate a locking pin to connect and/or lock the carrier 100 to the vehicle hitch 200. The hitch attachment lever(s) 158 are located on a side of the carrier 100 opposite that of the hitch attachment member 150. In addition, a locking aperture 160 can be provided to receive a padlock to lock the hitch attachment lever 158 in place.

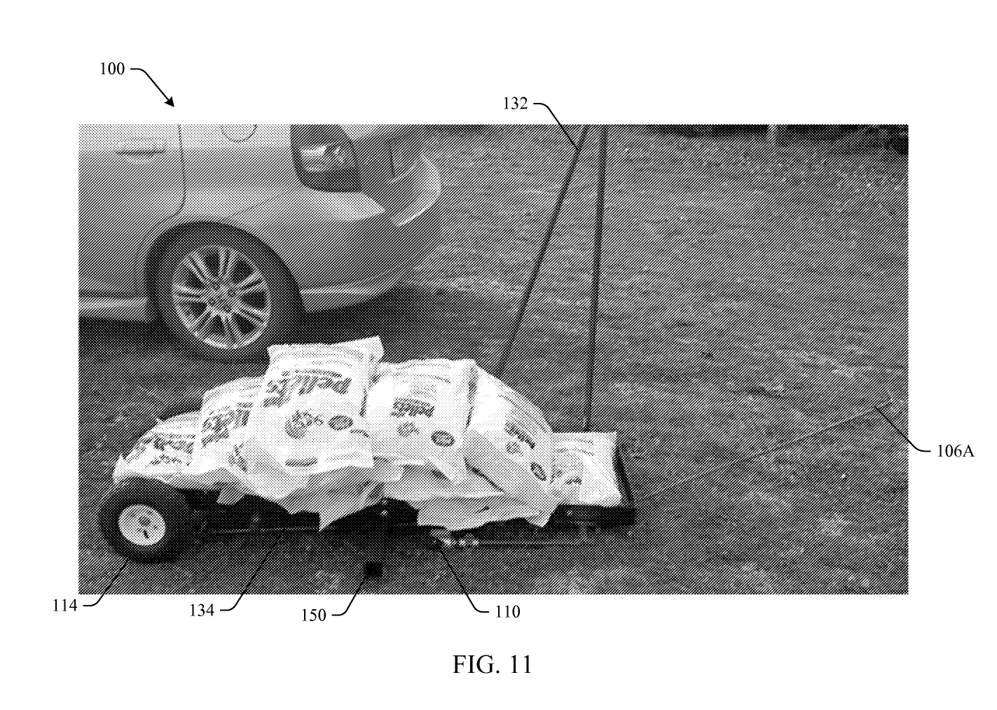

FIG. 9 is an illustration of the cargo carrier 100 attached to a rear of a vehicle via the vehicle hitch 200 described above. As can be seen from FIG. 9, when the cargo carrier 100 is attached to the vehicle the front connector 128 and rear axle 130 are in a retracted state, as described above, to provide additional clearance between the wheels 110, 114 and the ground.

In another example embodiment, the carrier 100 may include a lower cargo/tool tray for additional loading storage. A roll-up sheet may be added to the lower tray that transforms the lower tray from a mesh (semi-open) tray to a solid, non-open tray to prevent any debris falling through the lower tray.

In another example embodiment, the carrier 100 can be configured to dump its load (or perform specific kinematic/geometrical movements with an altered linkage design) using the same lever action as has already been described.

In another example embodiment, the carrier 100 may include tool receiver devices 162 (see FIG. 1), which may be tubing, rods, etc. attached to the carrier 100, disposed on any side, front, or rear wall to hold smaller hand tools.

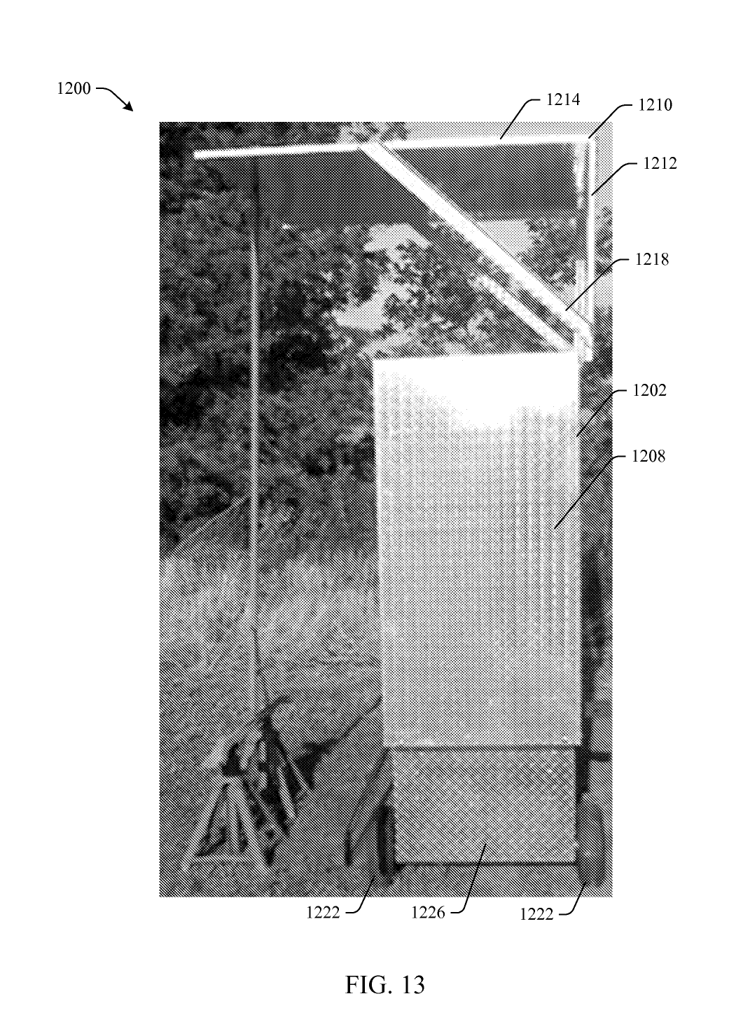

FIGS. 12 and 13 are illustrations of another embodiment of a cargo carrier/storage device 1200 in accordance with an aspect of the innovation. The embodiment illustrated in FIGS. 12 and 13 is similar to the embodiment described above, thus, like features between the embodiments will not be repeated.

The example embodiment includes a loading bed comprised of a compartment 1202 for transport and/or storage that sits upon a framed assembly 1204. The compartment includes a bottom panel 1206, side wall panels 1208, and a hatch 1210 that opens and closes. The hatch 1210 is comprised of a top panel 1212 and a side wall panel (hatch side panel) 1214. One or more support members 1218 that attach to both the top panel 1212 and the additional side wall panel 1214 may be included for additional support. When the hatch 1210 is in a closed position, the compartment 1202 is fully enclosed by the bottom panel 1206, the side walls 1208, 1214, and the top panel 1212.

A lower loading bed 1216 for additional storage may be provided that attaches to a bottom of the framed assembly 1204. The lower loading bed 1216 serves as a front connector to support front wheels 1220. More specifically, front wheels 1220 (e.g., castor type wheels) may be mounted to a bottom surface of the lower loading bed 1216 and have the capability to rotate freely.

Rear wheels 1222, similar to the rear wheels described above, may be connected to a rear portion of the lower loading bed 1216 or may be connected together via an axle 1224 similar to that described above.

The framed assembly 1204 includes an interconnection of rods or tubes that area arranged horizontally, vertically, angled, etc. attaches to a top surface of the lower loading bed 1216 and supports the compartment 1202. Lower vertically arranged panels may be provided in lieu of rods or tubes. For example, a lower rear panel 1226 is illustrated in FIGS. 12 and 13 and includes side panels 1228. In the illustrated embodiment, the rear axle 1224 extends through apertures defined in a lower portion of the side panels 1228. In addition, the rear portion if the lower loading bed 1216 is attached to an inner surface of each side panel 1228. Thus, the rear portion of the lower loading bed 1216, the rear axle 1224 and, hence the rear wheels 1222, and the lower rear panel 1226 are all interconnected.

The cargo carrier 1200 in this embodiment, as above, also includes a retracting lever 1230. The retracting lever 1230 is connected to a top front portion of the framed assembly 1204 and to a front portion of the lower loading bed 1216. Moving the retracting lever 1230 in a counterclockwise direction, from the position as shown in FIG. 12, pivots the retracting lever 1230 about a point P3 and the lower rear panel 1226 about a point P4, thus, retracting the front wheels 1220, the rear wheels 1222, and the lower loading bed 1216 rearward and upward, as illustrated above. Thus, the retracting lever 1230, the lower loading bed 1216, and the lower rear panel 1226 form a retractable assembly.

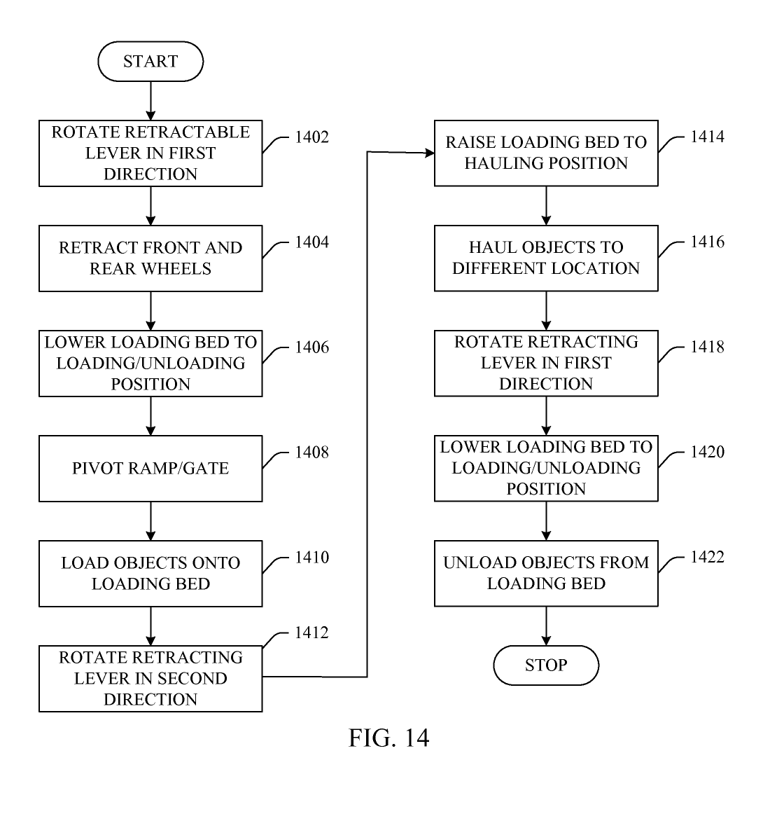

FIG. 14 is a flow chart illustrating a method of loading/unloading objects to/from the cargo carrier described above. For illustrative purposes only, the embodiment illustrated in FIGS. 1-10 will be referenced. At 1402, the retractable lever 132 is rotated in a first direction. At 1404, the front and rear wheels 110, 114 are retracted rearward and upward toward the loading bed 102. At 1406, the loading bed 102 is lowered to the loading/unloading position. At 1408, the ramp/gate 104 is rotated or pivoted in the direction indicated by the arrow Al thereby serving as an extension of the loading bed. At 1410, objects are loaded on the loading bed. At 1412, the retracting lever 132 is rotated in a second direction. At 1414, the loading bed 102 is raised to a hauling position. At 1416, the objects are hauled to a different location. At 1418, the retracting lever 132 is rotated in the first direction. At 1420, the loading bed 102 is lowered to the loading/unloading position. At 1422, the objects are unloaded from the loading bed 102.

Several advantages to the innovative cargo carrier 100 described herein include the use of a simple retracting handle to facilitate a low cost, robust design, that is easily and safely operated. The retracting handle improves the ability of an operator to collapse and lift the carrier under a load. This configuration provides an ergonomically friendly walking reward parallel to the cart during this leverage application.

Another advantage includes the ability to maximize ground clearance with a high ratio down-tube axle supports and/r maximize cart rigidity with a box structure frame axle members.

Another advantage is that the retractable feature permits the carrier 100 to ship in a compacted form while being nearly fully assembled.

Still another advantage is that the kinematic relationship of the front and rear axles can be configured to provide for loading alteration and raised cart axle, horizontal positions to allow for design intent operational characteristics (i.e., if self-trailing is desired for lawn tractor pulled operation, the front and rear axles can be justified rearward in the design). In another example embodiment, if reduced rolling resistance is desired, larger wheels on a forward justified axle can be provided.

It is to be understood that the cargo carrier described herein and illustrated in the figures is one example embodiment that is for illustrative purposes only and is not intended to limit the scope of the innovation. For example, the cargo carrier may include a rigid or flexible cover having side walls, a top, and a door and, thus, serve as a mini cargo/storage carrier. Further, the cargo carrier may include pouches or pockets along one or more sides for storage capabilities.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cargo carrier comprising:
a loading bed;
a removable handle attached to the loading bed;
a pair of retractable front wheels attached to the loading bed;
a pair of retractable rear wheels attached to the loading bed; and
a retractable assembly connected to the retractable front wheels and the retractable rear wheels,
wherein actuation of the retractable assembly retracts the retractable front wheels and the retractable rear wheels rearward and upward toward the loading bed.

2. The cargo carrier of claim 1, further comprising a ramp/gate pivotally attached to a front of the loading bed, wherein the ramp/gate pivots downward and serves as an extension of the loading bed for loading and unloading of objects,

3. The cargo carrier of claim 2, wherein the loading bed includes a pair of oppositely disposed side walls and a rear wall and wherein the ramp/gate, the pair of oppositely disposed sidewalls, and the rear wall form an open-top enclosure around a perimeter of a base of the loading bed.

4. The cargo carrier of claim 1, wherein the removable handle pivots for hauling the cargo carrier.

5. The cargo carrier of claim 1, wherein the removable handle is a hand tool,

6. The cargo carrier of claim 1, further comprising gas powered actuators for balancing leverage force inputs when transitioning the cargo carrier from a collapsed position to a raised position,

7. The cargo carrier of claim 1, wherein the loading bed includes a bottom panel, a plurality of side wall panels, and a movable hatch.

8. The cargo carrier of claim 7, wherein the hatch includes a top panel and a side wall panel, and wherein when the hatch is in a closed position, the bottom panel, the plurality if side wall panels, and the hatch form an enclosed compartment.

9. The cargo carrier of claim 1 further comprising a lower loading bed that transports and/or stores objects.

10. A utility cart for hauling and storing objects comprising:
a loading bed;
a pair of front wheels attached to the loading bed;
a pair of rear wheels attached to the :loading bed;
a retractable assembly including a lever and at least one connecting rod connecting the front wheels and the rear wheels; and
a hitch attachment member attached to a side of the cargo carrier for attachment of the cargo carrier to a vehicle hitch.

11. The utility cart of claim 10, wherein the hitch attachment member includes a pivot attachment tube that allows the utility cart to fold up when attached to the vehicle.

12. The utility cart of claim 10, wherein the hitch attachment member includes a tapered end and bearings that facilitate the insertion of the hitch attachment member into the vehicle hitch.

13. The utility cart of claim 10, wherein actuation of the retractable ;assembly retracts the front wheels and the rear wheels rearward and upward toward the loading bed to a transport position when the cargo carrier is attached to the vehicle hitch.

14. The utility cart of claim 10 further comprising a ramp/gate pivotally attached to a front of the loading bed, wherein the ramp/gate pivots downward and serves as an extension of the loading bed for loading and unloading of objects.

15. The utility cart of claim 14, wherein the loading bed includes a pair of oppositely disposed side walls and a rear wall and wherein the ramp/gate, the pair of oppositely disposed sidewalls, and the rear wall form an open-top enclosure around a perimeter of a base of the loading bed.

16. The utility cart of claim 10, wherein the loading bed includes a bottom panel, a plurality of side wall panels, and a movable hatch.

17. The utility cart of claim 16, wherein the hatch includes a top panel and a side wall panel, and wherein when the hatch is in a closed position, the bottom panel, the plurality if side wall panels, and the hatch form an enclosed compartment.

18. A method of loading/unloading objects from a cargo carrier for hauling comprising:
rotating a lever in a first;
retracting front and rear wheels rearward and upward toward a loading bed;
lowering the loading bed to a loading/unloading position;
pivoting a ramp attached to the loading bed thereby extending the loading bed; and
loading objects on the loading bed.

19. The method of claim 18 further comprising:
rotating the lever in a second direction;
raising the loading bed to a hauling position; and
hauling the objects to a different location.

20. The method of claim 19 further comprising:
rotating the lever in the first direction;
lowering the loading bed to the loading/unloading position; and
unloading the objects from the loading bed.
